(19) United States
(12) Patent Application Publication
(10) Pub. No.: US 2009/0088220 A1
(43) Pub. Date: Apr. 2, 2009

(54) CELLULAR TERMINALS AND OTHER ELECTRONIC DEVICES AND METHODS USING ELECTROACTIVE POLYMER TRANSDUCER INDICATORS

(75) Inventor: Truls Torben Persson, Sodra Sandby (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/865,233

(22) Filed: Oct. 1, 2007

(51) Int. Cl. H04M 1/00

(52) U.S. Cl. 455/567; 455/569.1

(57) ABSTRACT

Mobile electronic devices and methods are disclosed that operate an electroactive polymer (EAP) transducer to provide tactile indications to a user. A mobile electronic device can include a housing with at least one EAP transducer that is at least partially disposed in a surface of the housing. The EAP transducer has first and second electrodes with an EAP material coupled therebetween. An EAP excitation controller controls an electric field across the first and second electrodes to regulate deformation of the EAP material. The mobile electronic device can include a communication controller that communicates with a wireless communication device using at least one wireless communication protocol. The communication controller generates an alert signal in response to receiving a phone call/data message from the wireless communication device. The EAP excitation controller responds to the alert signal by repetitively varying the electric field across the EAP transducer to generate a vibration therefrom.

### FIELD OF THE INVENTION

The present invention relates to cellular terminals and other electronic devices using vibration/ringer indicators.

### BACKGROUND OF THE INVENTION

Many electronic devices such as cellular terminals and pagers include indicators to alert a user that something has happened or that some action is required. For example, an audible ringer can be used to indicate that a telephone call is being received or that a page has been received. Alternately, a vibrating assembly that causes a cellular terminal to vibrate can be used to provide silent indication. Such vibrating assemblies typically include a small electric motor, referred to as a vibrator motor, that drives a rotating shaft having an unbalanced or “eccentric” weight (i.e., a weight with a center of gravity that is radially displaced from the axis of rotation), thereby causing a vibration when the shaft rotates.

Unfortunately, conventional vibrator assemblies can be damaged when electronic devices containing them are dropped. Because the vibrator assemblies can be located deep within cellular terminal housings, they may need to provide sufficiently high amplitude vibrations to be sensed by a user through the housing. The frequency of a vibrator assembly typically operates near its resonance frequency to provide increased vibration per unit power, and the resulting indicator frequency is usually constrained to that resonance frequency.

### SUMMARY OF THE INVENTION

Various embodiments of the present invention are directed to mobile electronic devices and methods that operate an electroactive polymer (EAP) transducer to provide tactile indications to a user.

In some embodiments, a mobile electronic device includes a housing with at least one EAP transducer that is at least partially disposed in a surface of the housing. The EAP transducer has first and second electrodes with an EAP material coupled therebetween. An EAP excitation controller is configured to control an electric field across the first and second electrodes to regulate deformation of the EAP material.

In some further embodiments, the mobile electronic device further includes a communication controller that is configured to communicate with a wireless communication device over an air interface using at least one wireless communication protocol. The communication controller generates an alert signal in response to receiving a phone call and/or a data message from the wireless communication device. The EAP excitation controller responds to the alert signal by repetitively varying the electric field across the EAP transducer to generate a vibration therefrom.

In some further embodiments, the communication controller generates a first alert signal in response to receiving a phone call and a second alert signal, which is different than the first alert signal, in response to receiving a data message. The EAP excitation controller varies the electric field across the EAP transducer according to a first waveform in response to the first alert signal so as to generate a first vibration response therefrom, and varies the electric field across the EAP transducer according to a second waveform, which is different than the first waveform, in response to the second alert signal so as to generate a different second vibration response therefrom.

In some further embodiments, the mobile electronic device further includes at least three EAP transducers spaced apart on a common side of the housing. The EAP excitation controller sequentially excites each of the at least three EAP transducers in a first pattern over time in response to receiving a phone call and sequentially excites each of the at least three EAP transducers in a second pattern over time, which is different than the first pattern, in response to receiving a data message.

In some further embodiments, the communication controller generates a first alert signal in response to receiving a phone call having a first defined caller phone number, and generates a second alert signal, which is different than the first alert signal, in response to receiving a phone call having a second defined caller phone number. The EAP excitation controller varies the electric field across the EAP transducer according to a first waveform in response to the first alert signal so as to generate a first vibration response therefrom, and varies the electric field across the EAP transducer according to a second waveform, which is different than the first waveform, in response to the second alert signal so as to generate a different second vibration response therefrom.

In some further embodiments, in response to receiving a phone call and/or a data message from the wireless communication device, the communication controller uses the alert signal to trigger a ring tone to be generated by a speaker when the mobile electronic device has not been set in a mute mode by a user, and uses the alert signal to trigger vibration of the EAP transducer, via the EAP excitation controller, when the mobile electronic device has been set in a mute mode by a user.

In some further embodiments, the mobile electronic device further includes a user interface, a camera, and a camera controller. The camera captures digital pictures and/or digital video image streams. The camera controller initiates capture by the camera of a digital picture and/or a digital video stream and generates an associated alert signal in response to a user actuating a defined portion of the user interface. The EAP excitation controller responds to the alert signal by varying the electric field across the EAP transducer to deform the EAP transducer and provide tactile feedback to the user of the initiated capture by the camera.

In some further embodiments, the mobile electronic device further includes at least first and second EAP transducers spaced apart on the housing. The EAP excitation controller separately controls the electric fields across the first and second EAP transducers to provide a variable time delay between excitation of the first EAP transducer and excitation of the second EAP transducer. The EAP excitation controller may control the electric field across the first EAP transducer according to a first electric field waveform, and may control the electric field across the second EAP transducer according to a time-delayed first electric field waveform so as to provide a directional excitation sensation to a user. The mobile electronic device may include a gaming controller that generates directional feedback signals while executing a user-interactive game. The EAP excitation controller may regulate length of the time delay, between exciting the first EAP transducer according the first electric field waveform and exciting the second EAP transducer according to the first electric field waveform, in response to the directional feedback signals to provide a directional excitation feedback sensation to a user of the game.

In some further embodiments, the first EAP transducer extends along at least a portion of one side of the housing and the second EAP transducer extends along at least a portion of another opposite side of the housing. The mobile electronic device may further include a keypad and a display on a front of the housing. The first EAP transducer can extend along at least a portion of one side of the housing adjacent to the keypad and the second EAP transducer can extend along at least a portion of the opposite side of the housing adjacent to the keypad.

In some further embodiments, the mobile electronic device further includes a speaker and a music controller that generates a music signal for the speaker in response to music data. The EAP excitation controller controls the electric field across the EAP transducer in response to the music signal. The EAP excitation controller may include a low pass filter that filters the music signal to generate a lower-frequency music signal, and an amplifier that amplifies the lower-frequency music signal across the EAP transducer to cause vibration therefrom that is at least substantially synchronized with music from the speaker.

In some further embodiments, the mobile electronic device further includes at least first and second EAP transducers spaced apart on the housing, and the EAP excitation controller repetitively alternates between exciting the first EAP transducer and then exciting the second EAP transducer at a rate that is regulated in response to music tempo in the music signal. The mobile electronic device may include at least three EAP transducers spaced apart on a common side of the housing, and the EAP excitation controller sequentially excites each of the at least three EAP transducers at a rate that is regulated in response to music tempo in the music signal.

Some other embodiments are directed to a method of operating a mobile electronic device with an EAP transducer that is at least partially disposed in a surface of a housing of the electronic device. The method includes controlling an electric field across at least EAP transducer having first and second electrodes with an EAP material coupled therebetween to regulate deformation of the EAP material.

In some further embodiments, a phone call and/or a data message is received from a wireless communication device over an air interface using at least one wireless communication protocol. An alert signal is generated in response to receiving the phone call and/or the data message. The electric field across the EAP transducer is repetitively varied in response to the alert signal to generate a vibration from the EAP transducer.

In some further embodiments, the method responds to a user actuation of a defined portion of a user interface of the electronic device by triggering a camera of the electronic device to capture a digital picture and/or a digital video stream and by generating an associated alert signal. The electric field across the EAP transducer is varied in response to the alert signal to deform the EAP transducer and provide tactile feedback to the user of the initiated capture by the camera.

In some further embodiments, the method generates directional feedback signals while executing a user-interactive game hosted on the electronic device. The electric fields are separately controlled across spaced apart first and second ones of the EAP transducers to provide a regulated time delay between excitation of the first EAP transducer and excitation of the second EAP transducer. The length of the time delay between excitation of the first and second EAP transducers is regulated in response to the directional feedback signals to provide a directional excitation feedback sensation to a user of the game.

In some further embodiments, a music signal is generated for a speaker of the electronic device in response to music data. The music signal is low pass filtered to generate a lower-frequency music signal. The lower-frequency music signal is amplified across the EAP transducer to cause vibration therefrom that is at least substantially synchronized with music from the speaker.

Other electronic devices and/or methods according to embodiments of the invention will be or become apparent to one with skill in the art upon review of the following drawings and detailed description. It is intended that all such additional electronic devices and methods be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiments of the invention. In the drawings:

FIGS. 1A, 1B, and 1C illustrate a front view, back view, and side view of an electronic device, respectively, that is configured as a mobile cellular communication terminal and has electroactive polymer transducers on side housing surfaces thereof according to some embodiments of the present invention;

FIG. 2 illustrates a side view of another communication terminal having a plurality of electroactive polymer transducers on a side housing surface thereof in accordance with some embodiments of the present invention;

FIG. 3 is a schematic block diagram, and associated operational methods, for a communication terminal and a cellular communication system that operate according to some embodiments of the present invention;

FIG. 4 is a schematic block diagram, and associated operational methods, for an excitation controller and an electroactive polymer transducer that operate according to some embodiments of the present invention.

FIG. 5 is a schematic block diagram, and associated operational methods, for an electronic device with electroactive polymer transducers that are excited by a music player according to some embodiments of the present invention.

FIG. 6 is a schematic block diagram, and associated operational methods, for an electronic device with electroactive polymer transducers that are excited by a music player according to some embodiments of the present invention.

### DETAILED DESCRIPTION OF EMBODIMENTS OF THE INVENTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

Some embodiments are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

For purposes of illustration and explanation only, various embodiments of the present invention are described herein in the context of mobile cellular communication terminals (“communication terminals”). It will be understood, however, that the present invention is not limited to such embodiments and may be embodied generally in any electronic device that includes at least one electroactive polymer (EAP) transducer. For example, embodiments of the present invention may be embodied in user interfaces for electronic games and/or music players.

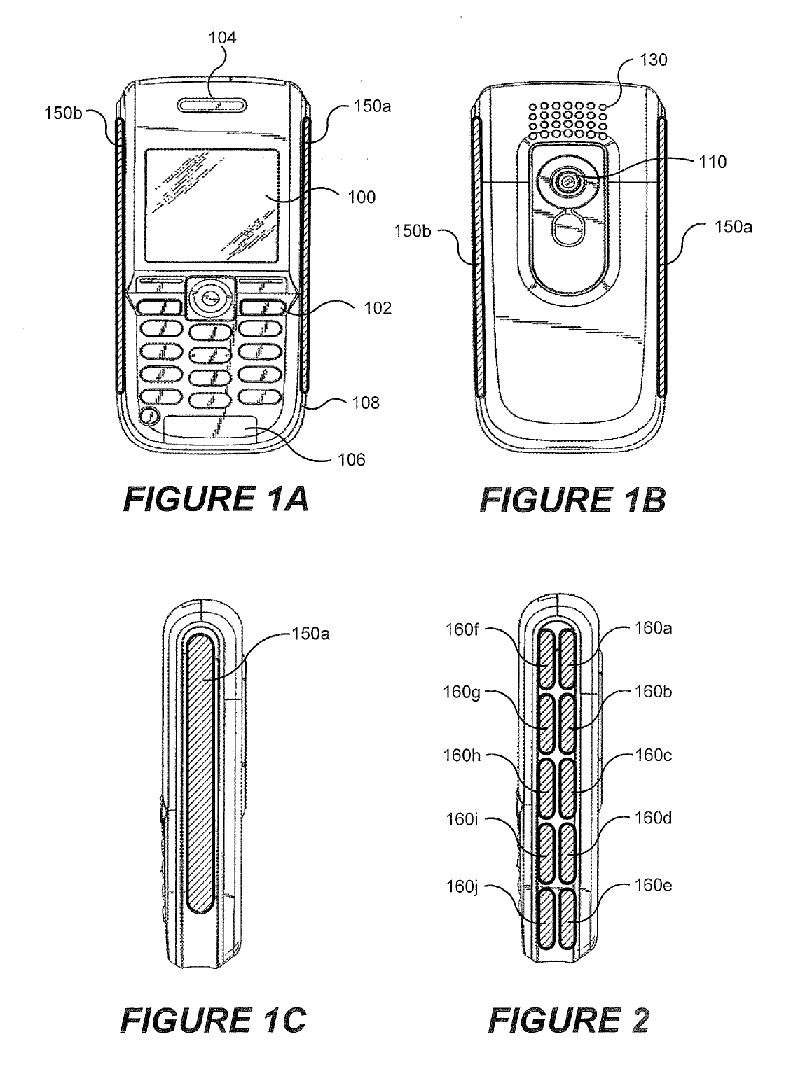

FIGS. 1A, 1B, and 1C respectively illustrate front, back, and side views of an electronic device that is configured as a communication terminal and operates according to some embodiments of the present invention. Referring to the front, back, and side views shown in FIGS. 1A, 1B, and 1C, the communication terminal may include a display 100, a user interface 102 (e.g., keypad), a speaker 104, and a microphone 106 disposed in a front surface of a housing 108. The communication terminal may further include a camera 110 and a larger loudspeaker 130 disposed in a back surface of the housing 108.

In accordance with some embodiments of the present invention, the communication terminal includes a pair of EAP transducers 150a-150b that are at least partially disposed in opposite sides of the housing 108. The EAP transducers 150a-150b extend along the side surfaces of the housing 108 along a region that is typically gripped by a user while holding the communication terminal. Various electronics of the communication terminal excite the EAP transducers 150a-150b to provide tactile feedback to a user gripping the EAP transducers 150a-150b or who is otherwise contacting the communication terminal and can thereby sense vibration therefrom. As will be explained further below, the excitation electronics can separately control an electric field (e.g., control waveform amplitude, duty cycle/frequency, rate of increase/decrease in waveform amplitude, etc.) applied to each of the EAP transducers 150a-150b to provide simultaneous, time delayed, or different stimulation responses therefrom.

Although the exemplary embodiments of FIGS. 1A-C and 2 illustrate that an outer surface of the EAP transducers can be directly touched by a user to allow sensing movement, it is to be understood that, according to some other embodiments, the EAP transducers can be covered by the housing and/or by another structural material. For example, the EAP transducers may be covered by a flexible material which may serve to protect the EAP transducers and/or to provide certain desirable cosmetic features.

FIG. 2 illustrates a side view of another communication terminal having ten EAP transducers 160a-j that are at least partially disposed within a side housing surface of the communication terminal. As will be explained further below, excitation electronics of the communication terminal can separately control an electric field applied to each of the EAP transducers 160a-j so as to separately control the responses therefrom. For example, the EAP transducers 160a-j may be sequentially excited according to a defined pattern, such as from top to bottom (e.g., excited in the following sequential order 160a, 160b, 160c, 160d, 160e, 160f, 160g, 160h, 160l, 160j), and/or in a zig-zag bottom-up pattern (e.g., excite in the following sequential order 160j, 160e, 160l, 160d, 160h, 160c, 160g, 160b, 160f, 160a).

As will be appreciated, although various embodiments of the communication terminal are illustrated in FIGS. 1A-1C and 2 with various numbers of EAP transducers located along side surfaces thereof for ease of illustration and explanation, the invention is not limited thereto. Instead, any number of EAP transducers may be at least partially disposed in one or more surfaces of an electronic device and controlled in accordance with various embodiments of the present invention.

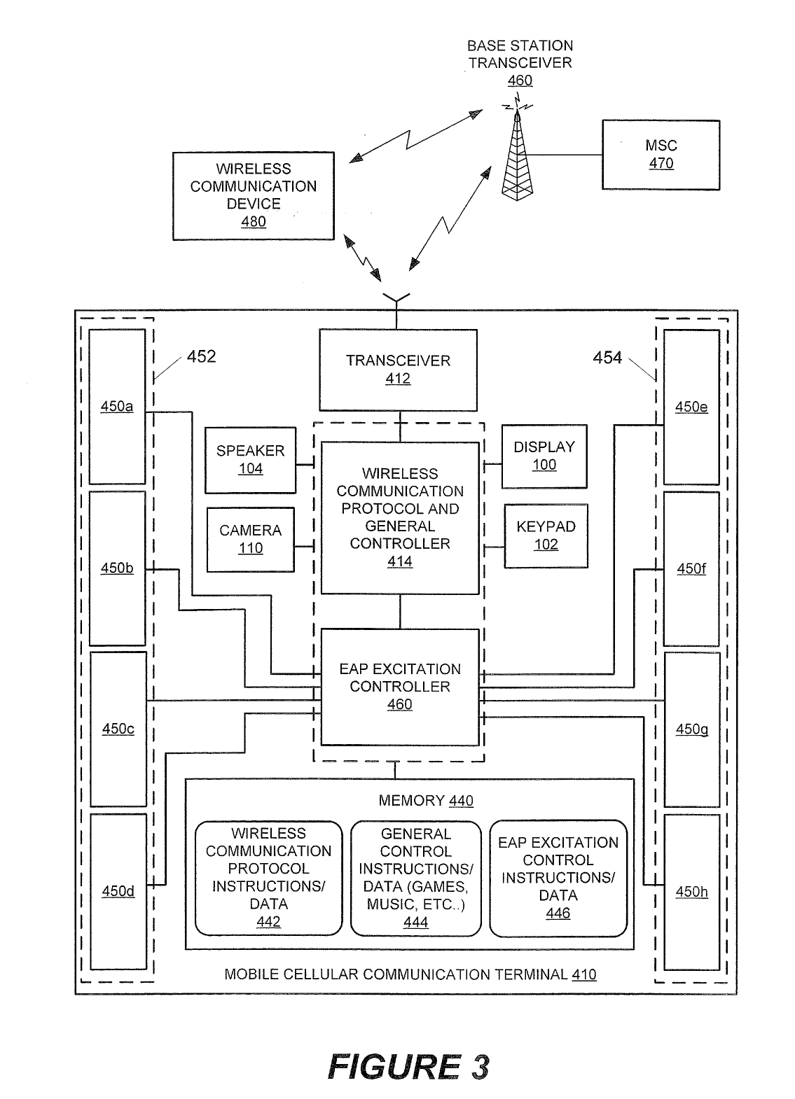

FIG. 3 is a schematic block diagram illustrating a communication terminal 410 and a cellular communication system in accordance with some embodiments of the present invention. The communication terminal 410 may be similar to the communication terminals of FIGS. 1A-C and 2, but the communication terminal 410 controls eight EAP transducers 450a-h. In the exemplary embodiment, four of the EAP transducers 450a-d may be arranged in a first pattern (e.g., dashed outline 452) along one side/front/back/top/bottom surface of the communication terminal 410, and the other four EAP transducers 450e-h may be arranged in a different second pattern (e.g., dashed outline 454) along an opposite side/front/back/top/bottom surface.

The communication terminal 410 may communicate with a cellular base station transceiver 460 connected to a mobile switching center (“MSC”) 470, and/or it may communicate through a short range network directly with another wireless communication device 480. The communication terminal 410 can therefore include a transceiver 412 and a wireless communication protocol controller (“communication controller”) 414 that are configured to communicate through a wireless air interface with the base station transceiver 460 and/or with the other wireless communication device 480. The transceiver 412 typically includes a transmitter circuit and a receiver circuit which cooperate to transmit and receive radio frequency signals. The communication controller 414 can be configured to encode/decode and control communications according to one or more cellular protocols, which may include, but are not limited to, Global Standard for Mobile (GSM) communication, General Packet Radio Service (GPRS), enhanced data rates for GSM evolution (EDGE), code division multiple access (CDMA), wideband-CDMA, CDMA2000, and/or Universal Mobile Telecommunications System (UMTS). The communication controller 414 may alternatively or additionally encode/decode and control communications according to one or more short range communication protocols, which may include, but are not limited to Bluetooth and/or WiFi such as IEEE 802.11 (e.g., IEEE 802.11b-g).

The communication terminal 410 can include the display 100, the user input interface 102 (e.g., keypad), the speaker 104, and the camera 110.

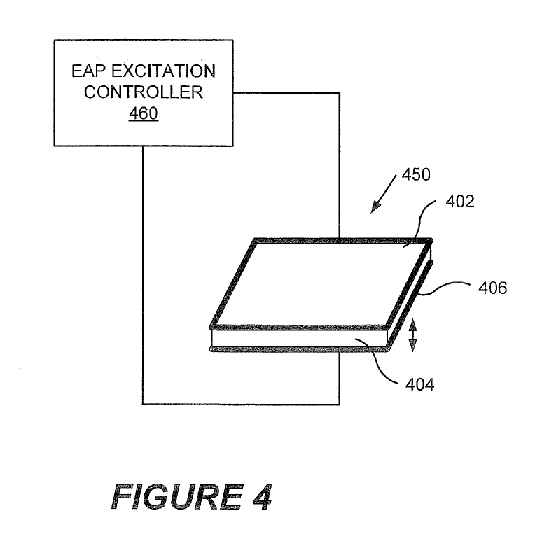

An EAP excitation controller 460 controls electric fields that can be separately applied to each of the EAP transducers 450a-h. Each of the EAP transducers 450a-h may be configured as shown in the block diagram of FIG. 4. The exemplary EAP transducer 450 includes a first electrode 402 and a second electrode 404, and an EAP material 406 coupled therebetween. The excitation controller 460 controls an electric field across the first and second electrodes 402 and 404 to regulate attractive forces therebetween and, resultantly, deformation of the EAP material 406 (i.e., variation in thickness of the EAP material 406). To cause a larger variation in thickness in response to stimulation, the EAP transducer 450 may be formed by stacking a plurality of layers of the first electrode 402, EAP material 406, and second electrode 404. The excitation controller 460 and regulates the rate at which the voltage across the electrodes 402 and 404 increases and decreases (e.g., rate at which the voltage rises from zero volts to full voltage and/or from fold voltage to zero volts) so as to control the rate of contraction/expansion of the EAP material 406. Thus, for example, the excitation controller 460 can control the EAP transducer 450 to rapidly contract the EAP material 406 to provide what a user may feel is a slap of the user's hand, or to slowly contract the EAP material 406 to provide what may feel like a slow shift/movement of the electronic device housing in the user's hand. An example EAP material that may be used therein is VHB 4910 made by 3M Corporation.

With continuing reference to FIG. 3, the excitation controller 460 can separately control each of the EAP transducers 450a-h, and may, for example, simultaneously excite all of the EAP transducers 450a-h with a time varying electric field to cause pulsing of their thicknesses, and which may be sensed by a user who is gripping at least some of the EAP transducers 450a-h or who is otherwise contacting the communication terminal 410. The EAP transducers 450a-h may be excited with a sufficiently high frequency electric field to cause the EAP transducers 450a-h to vibrate to facilitate sensing by a user who may not be directly contacting any of the EAP transducers 450a-h.

The communication controller 414 may generate an alert signal in response to receiving a phone call and/or a data message from the communication device 480 and/or from another communication device via, for example, the base station transceiver 460. When a user has not placed the communication terminal 410 in a mute mode, the communication controller 414 may generate a ring signal through the speaker 104. In contrast, when the communication terminal 410 has been placed in a mute mode, the excitation controller 460 may respond to the alert signal by repetitively varying the electric field across one or more of the EAP transducers 450a-h to generate vibration therefrom.

The excitation controller 460 may excite one or more of the EAP transducers 450a-h so as to provide different movements/vibrations therefrom that serve to indicate whether the communication terminal 410 is receiving an incoming call or an incoming message, and/or to indicate whether an incoming call/message matches one or more calling telephone numbers/originating messaging addresses that are defined in the communication terminal 410 (e.g., within a contact phone book).

In some embodiments, the communication controller 414 may generate a first alert signal in response to receiving a phone call and a second alert signal, which is different than the first alert signal, in response to receiving a data message. The excitation controller 460 can vary the electric field across one or more of the EAP transducers 450a-h according to a first waveform in response to the first alert signal so as to generate a first vibration response therefrom, and vary the electric field across the same or another EAP transducer 450a-h according to a second waveform, which is different than the first waveform, in response to the second alert signal so as to generate a different second vibration response therefrom. The first waveform may, for example, correspond to a first duty cycle square wave and the second waveform may correspond to a second duty cycle square wave. The first waveform may be configured to rapidly contract and expand selected ones of the EAP transducers 450a-h, while the second waveform may be configured to slowly contract and expand selected ones of the EAP transducers 450a-h.

In some further embodiments, the excitation controller 460 sequentially excites each of the EAP transducers 450a-h in a first pattern over time in response to receiving a phone call (e.g., excites 450a, 450b, 450c, 450d, 450e, 450f, 450g, and then 450h) and sequentially excites each of the EAP transducers 450a-h in a second pattern over time, which is different than the first pattern, in response to receiving a data message (e.g., excites 450h, 450g, 450f, 450e, 450d, 450c, 450b, and then 450a).

In some further embodiments, the EAP transducers 450a-h are controlled to provide an indication of whether an incoming call matches one or more defined calling telephone numbers (e.g., telephone numbers defined within a contact phonebook in the communication terminal 410). The communication controller 414 can generate a first alert signal in response to receiving a phone call having a first defined caller phone number, and can generate a second alert signal, which is different than the first alert signal, in response to receiving a phone call having a second defined caller phone number. The excitation controller 460 can vary the electric field across one or more of the EAP transducers 450a-h according to a first waveform (e.g., first duty cycle, rate of change in voltage, and/or amplitude square wave) in response to the first alert signal so as to generate a first vibration response therefrom, and can vary the electric field across the same or another one or more of the EAP transducers 450a-h to a second waveform (e.g., second duty cycle, rate of change in voltage, and/or amplitude square wave), which is different than the first waveform, in response to the second alert signal so as to generate a different second vibration response therefrom. Alternatively or additionally, the excitation controller 460 may sequentially excite each of the EAP transducers 450a-h according to different defined patterns over time to provide an indication as to who is calling.

In some further embodiments, the controller 414 can be configured to control the camera 110. The camera 110 captures digital pictures and/or digital video image streams. The controller 414 can initiate capture by the camera 110 of a digital picture and/or a digital video stream and can generate an associated alert signal in response to a user actuating a defined portion of the user interface 102 (e.g., responsive to a user pressing a camera picture/movie key on the keypad 102). The excitation controller 460 responds to the alert signal by exciting one or more of the EAP transducers 450a-h to provide tactile feedback to the user of the initiated capture by the camera 110.

In some further embodiments, the excitation controller 460 may separately control the electric fields across the EAP transducers 450a-h to provide a directional sensation to a user. The excitation controller 460 may provide a variable time delay between exciting a first group of the EAP transducers 450a-d (e.g., along a left side of the communication terminal 410) and exciting a second group of the EAP transducers 450e-h (e.g., along a right side of the communication terminal 410). The controller 414 can be configured as a gaming controller that generates directional feedback signals while executing a user-interactive game. The excitation controller 460 may regulate the rate of change of voltage provided to the EAP transducers 450e-h and/or the length of a time delay between exciting the first group of the EAP transducers 450a-d and exciting the second group of the EAP transducers 450e-h, in response to the directional feedback signals to provide a directional excitation feedback sensation to a user of the game. For example, the excitation controller 460 may excite the EAP transducers along a left side of the communication terminal 410 to cause a rapid expansion/contraction, which may be sensed as a relatively hard slap/pull on the user's hand, and may excite the EAP transducers along a right side of the communication terminal 410 to cause a slow expansion/contraction, which may be sensed as a relatively soft push/pull on the user's hand. By way of further example, the excitation controller 460 may excite the first group of EAP transducers 450a-d using a first electric field waveform and, after a defined time delay, may then execute the second group of EAP transducers 450e-h using the first electrode field waveform. The communication terminal 410 may thereby indicate that a game character has been impacted on the left side by rapidly expanding the EAP transducers along the left side of the communication terminal 410 and, after the defined time delay, more slowly expanding the EAP transducers along the right side of the communication terminal 410 to provide a directional feedback sensation to the user.

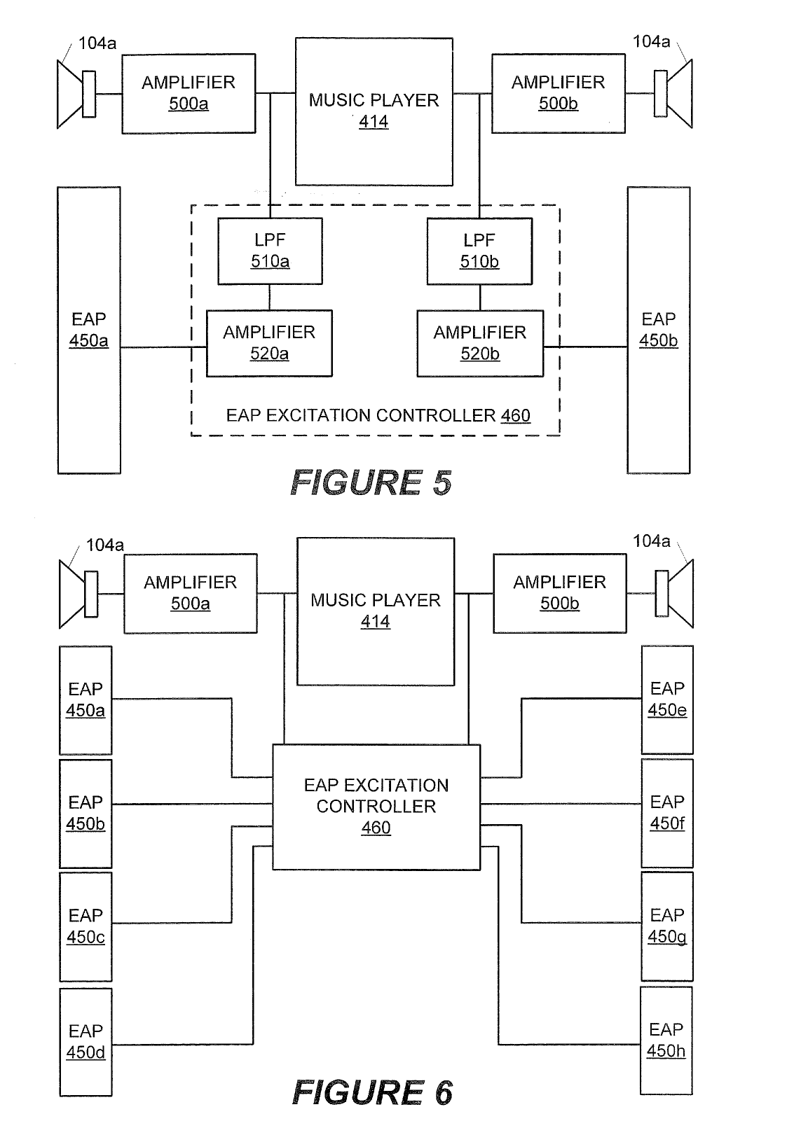

In some further embodiments that are explained below with regard to FIGS. 5 and 6, the controller 414 can be configured to generate a music signal for the speaker 104 in response to music data (e.g., configured as a MP3, WMA, and/or WAV music player). The excitation controller 460 can control the electric field across the EAP transducers 450a-h in response to the music signal.

Although various functionality of the communication terminal 410 has been shown in FIG. 3 within separate blocks, it is to be understood that two or more of these functions may be combined in a single physical integrated circuit package and/or the functionality described for one or the blocks may be spread across two or more integrated circuit packages. For example, the functionally described herein for the communication controller 414 and the excitation controller 460 may be combined within shared instruction execution circuitry, such as within a general purpose processor and/or a digital signal processor, that executes instructions within a memory 440. Accordingly, the memory 440 can include wirelessly communication protocol instructions and data 442, general control instructions and data 444 (e.g., video games, music player, etc.), and EAP excitation control instructions and data 446 that are executed by the instruction execution circuitry to carry out one or more of the embodiments described herein.

FIG. 5 is a schematic block diagram of an electronic device, such as the communication terminal 410 of FIG. 3, which includes a music player 414 (e.g., configured as a MP3, WMA, and/or WAV music player) that generates a pair of stereo music signals that are respectively amplified by a pair of amplifiers 500a-b and played through stereo speakers 104a-b. The excitation controller 460 excites first and second EAP transducers 450a-b in response to the music signal, which can be sensed before or after the amplifiers 500a-b. Because the music signal may include high frequencies that may improperly excite the transducers 450a-b, such as resulting in undesirable vibrations and/or reduce the operational amplitude and/or bandwidth of the transducers 450a-b, the excitation controller 460 may low-pass filter (LPF) the music signals using a pair of LPFs 510a-b that filter a respective one of the music signals. The filtered music signals can then be separately amplified by a pair of amplifiers 520a-b to a suitable level for exciting the EAP transducers 450a-b, such as to provide pulsing/vibration therefrom that is at least substantially synchronized with music from the speakers 104a-b.

FIG. 6 is a schematic block diagram of another electronic device, which includes the music player 414, amplifiers 500a-b, and speakers 104a-b of FIG. 5. In contrast to the excitation controller 460 of FIG. 5, the excitation controller 460 of FIG. 6 is configured to sequentially excite each of the EAP transducers 450a-h at a rate and/or with a pattern over time that is regulated in response to music tempo in the music signal. For example, the excitation controller 460 may sequentially excite the EAP transducers 450a-h at a first rate and/or first pattern over time in response to a first music tempo (e.g., a repeating pattern of exciting 450a, 450b, 450c, 450d, 450e, 450f, 450g, and then 450h in response to a music tempo less than a defined threshold), and sequentially excite the EAP transducers 450a-h at a different second rate and/or second pattern over time in response to a second music (e.g., a repeating pattern of exciting 450h, 450g, 450f, 450e, 450d, 450c, 450b, and then 450a in response to a music tempo greater than a defined threshold). The excitation controller 460 may excite the EAP transducers 450a-h according to other defined or random patterns to provide tactile feedback that may be synchronized with the music generated from the speakers 104a-b.

In the drawings and specification, there have been disclosed exemplary embodiments of the invention. However, many variations and modifications can be made to these embodiments without substantially departing from the principles of the present invention. Accordingly, although specific terms are used, they are used in a generic and descriptive sense only and not for purposes of limitation, the scope of the invention being defined by the following claims.

That which is claimed:

1. A mobile electronic device comprising:
a housing;
at least one electroactive polymer (EAP) transducer that is at least partially disposed in a surface of the housing, the EAP transducer having first and second electrodes with an EAP material coupled therebetween; and
an EAP excitation controller that is configured to control an electric field across the first and second electrodes to regulate deformation of the EAP material.

2. The mobile electronic device of claim 1, further comprising a communication controller that is configured to communicate with a wireless communication device over an air interface using at least one wireless communication protocol, wherein the communication controller generates an alert signal in response to receiving a phone call and/or a data message from the wireless communication device, and wherein the EAP excitation controller responds to the alert signal by repetitively varying the electric field across the EAP transducer to generate a vibration therefrom.

3. The mobile electronic device of claim 2, wherein:
the communication controller generates a first alert signal in response to receiving a phone call and a second alert signal, which is different than the first alert signal, in response to receiving a data message; and
the EAP excitation controller varies the electric field across the EAP transducer according to a first waveform in response to the first alert signal so as to generate a first vibration response therefrom, and varies the electric field across the EAP transducer according to a second waveform, which is different than the first waveform, in response to the second alert signal so as to generate a different second vibration response therefrom.

4. The mobile electronic device of claim 2, further comprising at least three EAP transducers spaced apart on a common side of the housing, wherein the EAP excitation controller sequentially excites each of the at least three EAP transducers in a first pattern over time in response to receiving a phone call and sequentially excites each of the at least three EAP transducers in a second pattern over time, which is different than the first pattern, in response to receiving a data message.

5. The mobile electronic device of claim 2, wherein:
the communication controller generates a first alert signal in response to receiving a phone call having a first defined caller phone number, and generates a second alert signal, which is different than the first alert signal, in response to receiving a phone call having a second defined caller phone number; and
the EAP excitation controller varies the electric field across the EAP transducer according to a first waveform in response to the first alert signal so as to generate a first vibration response therefrom, and varies the electric field across the EAP transducer according to a second waveform, which is different than the first waveform, in response to the second alert signal so as to generate a different second vibration response therefrom.

6. The mobile electronic device of claim 2, wherein:
in response to receiving a phone call and/or a data message from the wireless communication device, the communication controller uses the alert signal to trigger a ring tone through a speaker when the mobile electronic device has not been set in a mute mode by a user, and uses the alert signal to trigger vibration of the EAP transducer, via the EAP excitation controller, when the mobile electronic device has been set in a mute mode by a user.

7. The mobile electronic device of claim 1, further comprising:
a user interface;
a camera that is configured to capture digital pictures and/or digital video image streams;
a camera controller that is configured to initiate capture by the camera of a digital picture and/or a digital video stream and to generate an associated alert signal in response to a user actuating a defined portion of the user interface; and
wherein the EAP excitation controller responds to the alert signal by varying the electric field across the EAP transducer to deform the EAP transducer and provide tactile feedback to the user of the initiated capture by the camera.

8. The mobile electronic device of claim 1, further comprising at least first and second EAP transducers spaced apart on the housing, wherein the EAP excitation controller separately controls the electric fields across the first and second EAP transducers to provide a variable time delay between excitation of the first EAP transducer and excitation of the second EAP transducer.

9. The mobile electronic device of claim 8, wherein:
a gaming controller that is configured to generate directional feedback signals while executing a user-interactive game, wherein the EAP excitation controller regulates length of the time delay, between exciting the first EAP transducer and exciting the second EAP transducer in response to the directional feedback signals to provide a directional excitation feedback sensation to a user of the game.

10. The mobile electronic device of claim 1, further comprising:
at least first and second EAP transducers spaced apart on the housing; and
a gaming controller that is configured to generate directional feedback signals while executing a user-interactive game, wherein the EAP excitation controller separately controls the rate of change of electric field across each of the first and second EAP transducers in response to the directional feedback signals so that one of the first and second EAP transducers more rapidly contracts than the other one of the first and second EAP transducers to provide a directional excitation feedback sensation to a user of the game.

11. The mobile electronic device of claim 10, wherein the first EAP transducer extends along at least a portion of one side of the housing and the second EAP transducer extends along at least a portion of another opposite side of the housing.

12. The mobile electronic device of claim 11, further comprising a keypad and a display on a front of the housing, wherein the first EAP transducer extends along at least a portion of one side of the housing adjacent to the keypad and the second EAP transducer extends along at least a portion of the opposite side of the housing adjacent to the keypad.

13. The mobile electronic device of claim 1, further comprising:
a speaker; and
a music controller that is configured to generate a music signal for the speaker in response to music data, wherein the EAP excitation controller controls the electric field across the EAP transducer in response to the music signal.

14. The mobile electronic device of claim 13, wherein the EAP excitation controller comprises:
a low pass filter that filters the music signal to generate a lower-frequency music signal; and
an amplifier that amplifies the lower-frequency music signal across the EAP transducer to cause vibration therefrom that is at least substantially synchronized with music from the speaker.

15. The mobile electronic device of claim 13, further comprising at least first and second EAP transducers spaced apart on the housing, wherein the EAP excitation controller repetitively alternates between exciting the first EAP transducer and then exciting the second EAP transducer at a rate that is regulated in response to music tempo in the music signal.

16. The mobile electronic device of claim 15, further comprising at least three EAP transducers spaced apart on a common side of the housing, wherein the EAP excitation controller sequentially excites each of the at least three EAP transducers at a rate that is regulated in response to music tempo in the music signal.

17. A method of operating a mobile electronic device, the method comprising:
controlling an electric field across at least one electroactive polymer (EAP) transducer having first and second electrodes with an EAP material coupled therebetween to regulate deformation of the EAP material, wherein the EAP transducer is at least partially disposed in a surface of a housing of the electronic device.

18. The method of claim 17, further comprising:
receiving a phone call and/or a data message from a wireless communication device over an air interface using at least one wireless communication protocol;
generating an alert signal in response to receiving the phone call and/or the data message; and
repetitively varying the electric field across the EAP transducer in response to the alert signal to generate a vibration from the EAP transducer.

19. The method of claim 17, further comprising:
responding to a user actuation of a defined portion of a user interface of the electronic device by triggering a camera of the electronic device to capture a digital picture and/or a digital video stream and by generating an associated alert signal; and
varying the electric field across the EAP transducer in response to the alert signal to deform the EAP transducer and provide tactile feedback to the user of the initiated capture by the camera.

20. The method of claim 17, further comprising:
generating directional feedback signals while executing a user-interactive game hosted on the electronic device;
separately controlling the electric fields across spaced apart first and second ones of the EAP transducers to provide a variable time delay between excitation of the first EAP transducer and excitation of the second EAP transducer; and
regulating length of the time delay between excitation of the first and second EAP transducers in response to the directional feedback signals and/or regulating rate of change of electric field across each of the first and second EAP transducers to provide a directional excitation feedback sensation to a user of the game.

21. The method of claim 17, further comprising:
generating a music signal for a speaker of the electronic device in response to music data;
low pass filtering the music signal to generate a lower-frequency music signal; and
amplifying the lower-frequency music signal across the EAP transducer to cause vibration therefrom that is at least substantially synchronized with music from the speaker.
